(19) United States
(12) Patent Application Publication
(10) Pub. No.: US 2004/0031531 A1
(43) Pub. Date: Feb. 19, 2004

(54) Adjustable water pipe for cleaning

(76) Inventor: Jin-Yue Chiu, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/216,764

(22) Filed: Aug. 13, 2002

(51) Int. Cl. F16L 11/00

(52) U.S. Cl. 138/109; 138/108; 138/DIG. 8; 239/587.1

(57) ABSTRACT

An adjustable water pipe includes a connecting block, a conduit, a securing sleeve, and a metal wire. The conduit is flexible, and is firmly joined to the connecting block at a first end. The connecting block has a through hole and an outlet communicating with an inner space of the conduit. The securing sleeve is provided to press the first end of the conduit tightly against the block, preventing water from leaking through the joint. The metal wire has plasticity so that it can be bent into various shapes. The metal wire is placed along the inner space of the external conduit, and is firmly inserted into one end of the through hole of the connecting block, helping the conduit stay bent in conveying water after adjustment of position.

### BACKGROUND OF THE INVENTION

1. Field of the Invention

The present invention relates to an adjustable water pipe, which can be bent into various positions for allowing a person doing the cleaning with it to do his job easily with out having to climb up and down or enter the places to be cleaned, more particularly an adjustable water pipe, which can prevent water from leaking, and is not prone to be forced back to straight position by strong water current passing through it.

2. Brief Description of the Prior Art

It is very convenient to wash and clean places some parts of buildings, machines or automobiles with water pipes that are adjustable in position because the cleaning personnel can bend the pipe into various positions according to their needs. For example, the pipe can be bent for allowing persons doing the cleaning to wash high places without having to climb up to the high places, and vice versa. Small places where people cannot enter can be washed thoroughly with such adjustable pipe, too. And, people do not have to change their position frequently in cleaning with such pipe, saving them a lot of labor.

Referring to FIG. 5, a conventional adjustable pipe includes several sections 51 connected in a row. Each of the sections 51 has a round insertion portion 511 at one end, and a holding room 512 at the other end. The round insertion portion 511 of each of the sections 51 is inserted into the holding room 512 of the next section 51 so that the sections 51 can pivot on the adjacent sections, allowing the pipe to be adjusted in position. The first one of the sections 51 is joined to a nozzle 53. The last one of the sections 51 is joined to a connecting member 52, which is provided for connection with a faucet (not shown). Thus, the pipe has the above-mentioned function.

However, this pipe has disadvantages as followings:

1. Small spaces are likely to form between the round insertion portions 511 and the sections 51 connected thereto due to the way they are connected, making water leak through the pipe to cause the users a lot of inconvenience.

2. This pipe is not provided with any means that can make it stay in bent position after it is adjusted to the bent position. Consequently, this pipe is prone to be forced back to straight position by strong water current passing through it.

Referring to FIG. 6, to overcome the second disadvantage of the last pipe, another conventional adjustable pipe 6 is provided, which includes an exterior tube 61, a flexible coiled member 62, and an interior conduit 63. The exterior tube 61 is made of metal, and passed around the flexible coiled member 62. The interior conduit 63 is placed along the inner space of the flexible coiled member 62. The flexible coiled member 62 is provided to help the pipe stay bent after it is adjusted to bent position for use even if strong water current travels through the interior conduit 63.

However, this pipe has disadvantages as followings:

1. All extra conduit i.e. the interior conduit 63, is provided for preventing water from leaking through the exterior tube 61, consequently manufacturing cost of the pipe is increased.

2. The flexible coiled member 62 cannot be folded into two sections that are directed to a same direction, therefore the use thereof is somewhat limited. In other words, this pipe might be not able to be adjusted into suitable position in some circumstances.

### SUMMARY OF THE INVENTION

It is a main object of the present invention to provide an adjustable water pipe which can is not prone to be forced back to straight position by strong water current passing through it.

It is another object of the present invention to provide an adjustable water pipe that can be bent into any position.

The adjustable water pipe for cleaning according to the present invention includes a connecting block, a conduit, a securing sleeve, and a metal wire. The conduit is flexible, and is firmly joined to the connecting block such that water can travel through it via the block. The securing sleeve is provided to press the conduit tightly against the block, preventing water from leaking through the joint. The metal wire has plasticity to be bent into various shapes. The metal wire is placed along the inner space of the external conduit, and is firmly joined to the connecting block; thus, the conduit won't be forced back to straight position by the water current traveling through it after adjustment of position.

### BRIEF DESCRIPTION OF THE DRAWINGS

The present invention will be better understood by reference to the accompanying drawings, wherein:

FIG. 1 is a plan of the adjustable water pipe according to the present invention.

FIG. 2 is a perspective view of the adjustable water pipe according to the present invention.

FIG. 3 is a cross-section view of the adjustable water pipe according to the present invention.

FIG. 4 is a view of the adjustable pipe of the present invention in use.

FIG. 5 is a side view of the first conventional adjustable water pipe in the Background.

FIG. 6 is a side view of the second conventional adjustable water pipe in the Background.

### DETAILED DESCRIPTION OF THE PREFERRED EMBODIMENTS

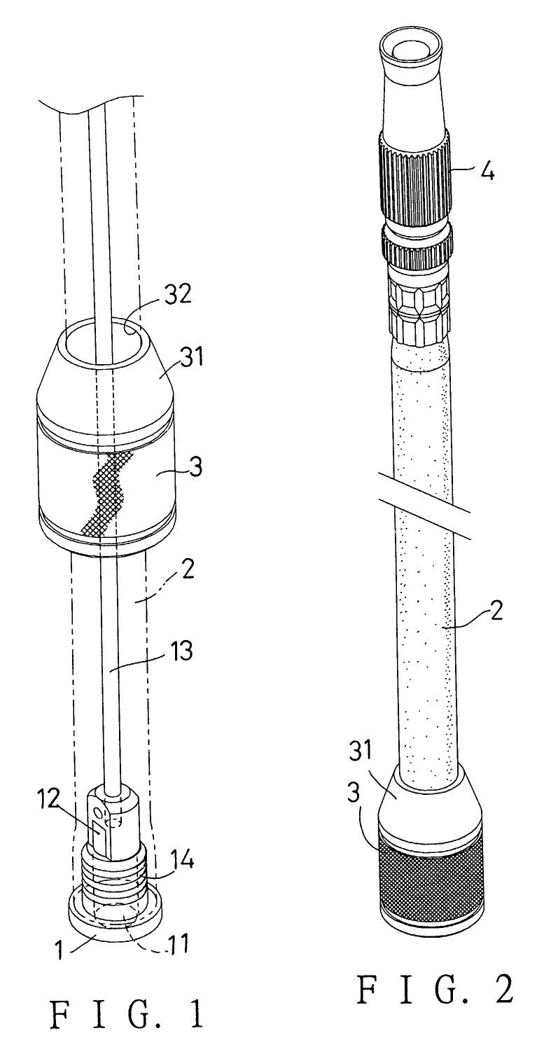

Referring to FIGS. 1 and 2, an adjustable water pipe for cleaning according to the present invention includes a connecting block 1, an external conduit 2, a securing sleeve 3, a metal wire 13 and a nozzle 4.

The external conduit 2 is flexible, and has openings at two ends thereof. The external conduit 2 is preferably made of plastics or PU.

The connecting block 1 has a through hole 11, and an outlet 12 communicating with the through hole 11. The connecting block 1 is further formed with annular protrusions 14.

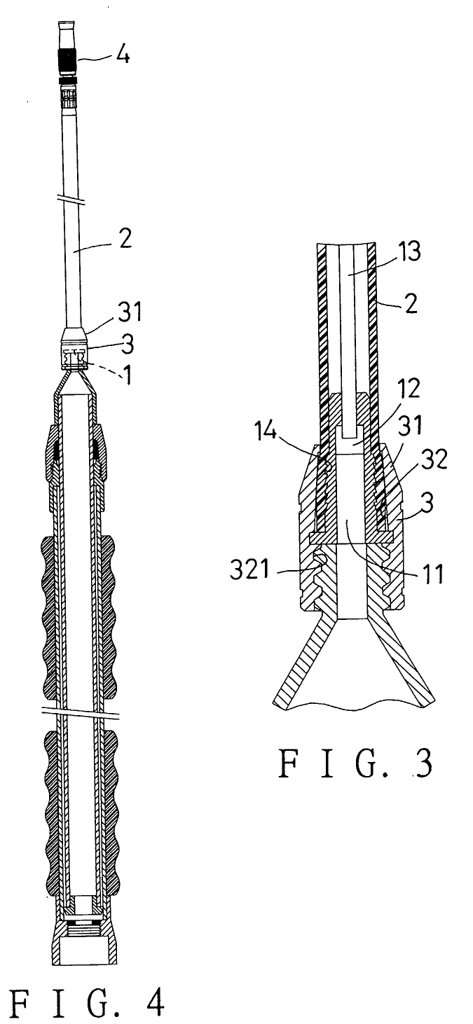

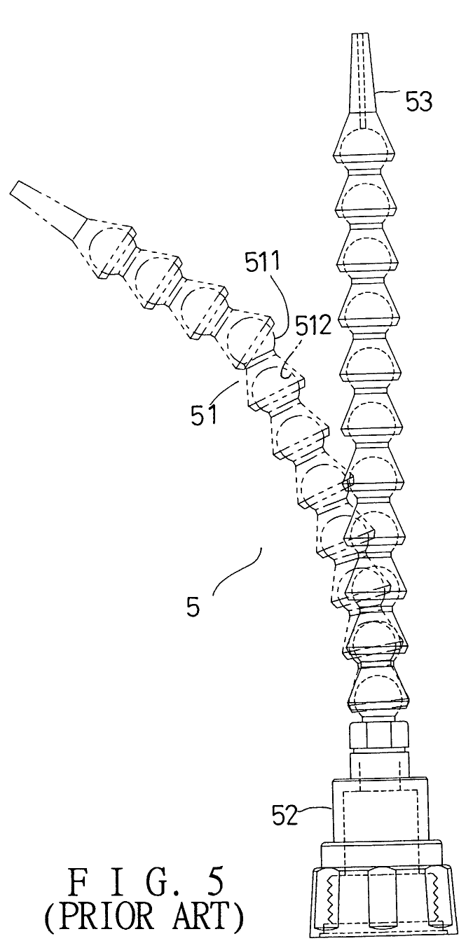

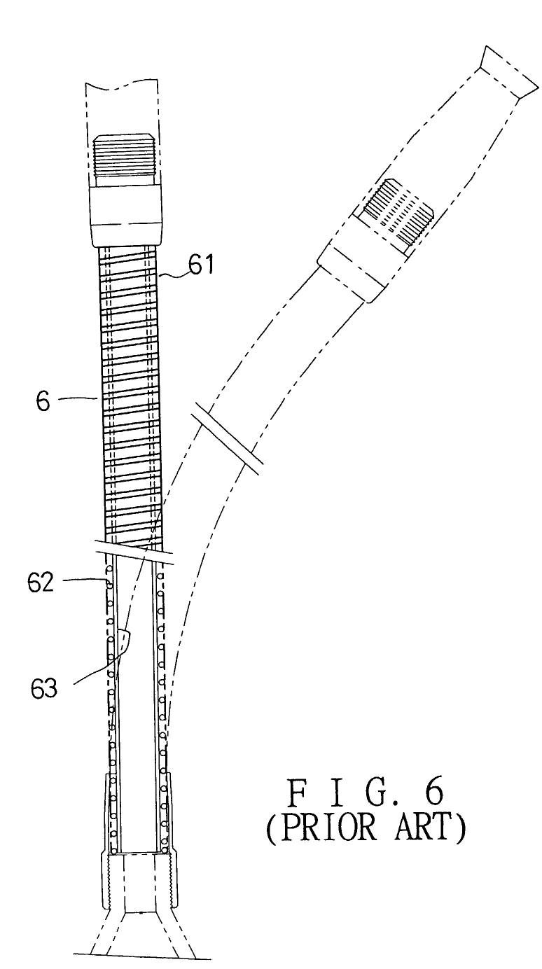

The securing sleeve 3 has a truncated-cone shaped portion 31 at an outer side, a through hole 32, and threads 321 (FIG. 3) on an inner side thereof The securing sleeve 3 is screwed onto other water pipe connected to external water supply by means of the threads 321 thereof.

The metal wire 13 has plasticity, and is made to have relatively low carbon content. The metal wire 13 can be made of galvanized iron.

In combination, the external conduit 2 is tightly passed around the annular protrusions 14 to be firmly joined to the connecting block 1 from one of the opening thereof, the outlet 12 of the connecting block 1 communicates with an inner space of the external conduit 2 so that water from external water supply can travel through the through hole 11, the outlet 12, and the conduit 2. The metal wire 13 is placed along the inner space of the external conduit 2, and is tightly inserted into an inner end of the through hole 11 of the connecting block 1 so that it is firmly joined to the connecting block 1. And, referring to FIG. 3, the securing sleeve 3 is tightly passed around the connecting block 1 from the through hole 32 so that that portion of the external conduit 2 connected to the block 1 is tightly pressed against the connecting block 1, preventing water from leaking through the joint. The nozzle 4 is connected to the other opening of the conduit 2 so that water can jet out for cleaning after traveling through the conduit 2.

In using the present pipe, the metal wire 13 can be adjusted to various bent positions together with the external conduit 2 so that the external conduit 2 can stay bent in conveying water with it due to the metal wire 13. Metal wires of different diameters can be used in the present pipe to fit the strength of water current to be passed through the pipe.

From the above description, it can be easily understood that the adjustable water pipe for cleaning according to the present invention has advantages as followings:

1. The pipe is provided with a securing sleeve, which presses the external conduit tightly against the annular protrusions of the connecting block. Therefore, water leakage through the joint will not happen to the pipe.

2. The metal wire helps the external conduit stay bent in conveying water after adjustment of position of the pipe. And, when the pipe is connected to water supply having relatively big water pressure, the metal wire can be replaced with one of bigger diameter to fit bigger strength of water current. Therefore, the pipe will not be forced back to straight position by strong water current passing through it.

3. Consisting of the sleeve, the connecting block, a wire, and only one conduit, the present pipe is relatively uncomplicated in structure, therefore the assembly is easy, and the manufacturing cost low.

What is claimed is:

1. An adjustable water pipe for cleaning, comprising
a flexible external conduit having a first opening and a second opening at two ends thereof;
a connecting block having a through hole, and an outlet communicating with the through hole; the connecting block being connected to the first opening of the external conduit with the outlet thereof communicating with an inner space of the external conduit so that water from external water supply can travel through the conduit via both the through hole and the outlet thereof;
a securing sleeve tightly passed around the connecting block to secure the connection of the connecting block with the external conduit;
a metal wire firmly connected to an inner end of the connecting block; the metal wire having plasticity and relatively low carbon content, and being placed along the inner space of the external conduit for helping the external conduit stay bent in conveying water with the pipe after the conduit is adjusted to a bent position together with the metal wire.

2. The adjustable water pipe for cleaning as claimed in claim 1, wherein the external conduit is made of PU.

3. The adjustable water pipe for cleaning as claimed in claim 1, wherein the external conduit is made of plastics.

4. The adjustable water pipe for cleaning as claimed in claim 1, wherein the securing sleeve is formed with threads on an inner side thereof for allowing same to be connected to other water pipes.

5. The adjustable water pipe for cleaning as claimed in claim 1, wherein the metal wire is made of galvanized iron.

6. The adjustable water pipe for cleaning as claimed in claim 1, wherein the metal wire is selected from metal wires of various diameters to fit strength of water current to be passed through the pipe.

7. The adjustable water pipe for cleaning as claimed in claim 1, wherein the securing sleeve is made to have a truncated-cone shaped portion on an outer side thereof.

8. The adjustable water pipe for cleaning as claimed in claim 1, wherein the connecting block is formed with annular protrusions, and the conduit is tightly passed around the annular protrusions at the first opening thereof.

9. The adjustable water pipe for cleaning as claimed in claim 1, wherein the metal wire is tightly inserted into an inner end of the through hole of the connecting block for the connection with the connecting block.
